(19) United States
(12) Patent Application Publication
(10) Pub. No.: US 2009/0049039 A1
(43) Pub. Date: Feb. 19, 2009

(54) MECHANISM FOR IMPROVING THE EFFECTIVENESS OF AN INTERNET SEARCH ENGINE

(76) Inventor: David Paul Austen RYLAND, Cambridge (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/192,158

(22) Filed: Aug. 15, 2008

(30) Foreign Application Priority Data
Aug. 15, 2007 (GB) GB0715889.2

(51) Int. Cl. G06F 17/30

(52) U.S. Cl. 707/5; 707/E17.017

(57) ABSTRACT

Large websites employ internal search engines to assist visitors of the site to access pages relevant to the visitor's needs. Such internal search engines generally use a specialist database containing information relevant to the website.

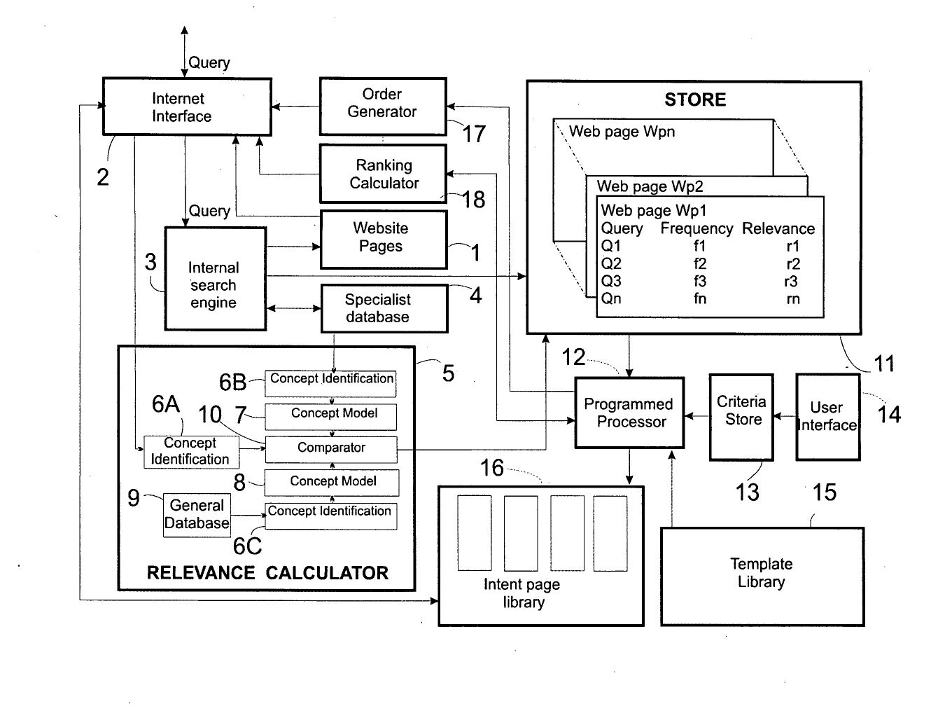

Internet search engines generally do not have access to the specialise databases and so the results they produce are frequently less useful than the results produced from the same query addressed to an internal search engine.

The effectiveness of the internet search engine is improved by the use of a store (11) of information for each page (1) of the website, the store (11) comprising a record of each query (Q1, Q2 . . . Qn) directed to the page, the frequency (f1, f2 . . . fn) of the query and the relevance (r1, r2 . . . rn) of the query as calculated by a relevance calculator (5).

Also included is a mechanism to generate, for each relevant query, an intent page (16) which contains the relevant query and a link to the webpage that it accessed. The intent pages (16) are made visible to the internet search engine thereby improving the efficiency by which users are directed to a relevant page.

### FIELD OF THE INVENTION

The present invention relates to a mechanism for improving the effectiveness of an internet search engine at directing a user to a relevant page of a website having an internal search engine.

### BACKGROUND OF THE INVENTION

Operators of large websites often employ internal search engines to assist visitors who have accessed one page of the website in finding another page relevant to the visitor's needs. Such internal search engines usually use a specialist database containing information relevant to the website, e.g. the content of the webpage, information on products, services etc.

A study carried out by the inventors revealed that as many as 8000 differently worded search queries may be used in an internet search engine by visitors seeking the same webpage/information. Of these, a small proportion of the phrases will be used by many users whereas the rest will be used by few users. However, the total number of less common query phrases still forms a substantial proportion of the total number of queries. Consequently, there is an obvious advantage to be obtained from a system which is able to interpret as many different wordings as possible and to direct the visitor to the appropriate webpage.

Because internet search engines generally do not have access to the content of specialist databases internal to websites, the results they produce are frequently less useful than the results produced from the same query addressed to an internal search engine. The present invention was conceived as a means to increase the effectiveness of an internet search engine's ability to direct users who have used less common search terms to a relevant web page.

### SUMMARY OF THE INVENTION

The invention provides a mechanism for improving the effectiveness of an internet search engine at directing a user to a relevant page of a website that has an internal search engine comprising:
i) an interface for connecting the mechanism to the internet
ii) a relevance calculator associated with the internal search engine for producing an indication of the relevance of a user query to information in the website;
iii) a store of information containing for each page of the website
   a record of each query which has been directed to that page,
   the frequency of the query directed to that page, and
   the relevance of the query as determined by (ii) above;
iv) means for selecting from item (iii) above web pages which are accessed by relevant queries; and
v) means for generating intent pages (as herein defined) for such relevant queries, each intent page containing the query and a link to the webpage that it accessed, and for making the intent pages visible to the internet search engine thereby improving the efficiency with which users are directed to a relevant page.

The term “intent page” as used in this specification is defined as any web page that is designed to capture the intent of users as expressed in a query that they have presented to the internal search engine.

By employing the invention it becomes possible to use the superior effectiveness of a website's internal search engine to improve to a significant extent, the effectiveness of an external internet search engine in directing users efficiently to the web page that contains the information or facilities that they require.

A preferred embodiment of the invention includes a store of criteria, which may be manually entered, defining the frequency and relevance values (or the value of a function that depends on both of them) which must be exceeded before an intent page is generated. It is also desirable to store a second criteria which, when exceeded, prompts an advertisement to be placed with an appropriate internet searching service, whereby users entering the relevant query will be shown a link to the appropriate page of the website.

### BRIEF DESCRIPTION OF THE DRAWING

One embodiment of the invention will now be described by way of example with reference to the accompanying schematic drawing which illustrates a system for increasing the effectiveness of an internet search engine in finding relevant web pages in a bank's website.

The drawing is highly schematic and some of the different blocks illustrate areas of computer memory or system functions determined by suitable programming of the computer. This programming can be in accordance with standard practice well known to those skilled in the art.

### DETAILED DESCRIPTION OF THE INVENTION

Referring now to the drawing there is shown a computer on which is stored a collection of website pages indicated generally by reference numeral 1. The computer is linked to the internet via an interface 2. The website has an internal search engine 3 and an associated specialist database 4.

A relevance calculator 5 comprises: concept identifying mechanisms 6A, 6B & 6C; concept models 7, 8; a general database 9; and a comparator 10.

Also included in the computer is a store 11 containing information related to the queries used to access individual web pages, a programmed processor 12, a criteria store 13 containing operator imputed rules; a template library 15 comprising web page templates associated with each webpage on the website and containing a link thereto; and an intent page library 16.

A company website (in this example for a bank) has a dedicated search engine 3 which derives results answering user queries by searching the specialist database 4 associated with the website. The specialist database 4 contains information that answers common questions asked by visitors, e.g. concerning bank accounts, mortgages, loans, chequebooks etc.

A user visiting selected pages of the site is invited to input a query to the search engine 3 which responds by interrogating the specialist database 4. Details of the web pages from collection 1 which are considered to be relevant to the query are presented to the user by way of a temporary web page generated by the search engine 3. The user selects the result considered to be most relevant whereupon the search engine 3 directs the user to the appropriate webpage of the collection 1.

The visitor's query is also entered into the concept identifier mechanism 6A, forming part of a relevance calculator 5, which identifies concepts within the visitor's query.

A concept can be thought of as a word or sequence of words with a defined meaning Also in the relevance calculator 5 is a hard drive containing a general database 9 which is around 100,000 times larger than the specialist database 4 holding random information on a broad spectrum of different topics including some information relevant to that held in the specialist database 4.

The concept identifier mechanisms 6B and 6C are used to identify all concepts present in respective databases 4 and 9 and to produce concept models 7, 8 which store the relative frequency of each concept relative to the total number of concepts in each database.

A comparator 10 compares the relative frequencies that the identified concept(s) in the query occur in both the specialist and random databases 4, 9 and produces an output being indicative of the relative relevance of the results by the specialist database 4 to the query, as compared with the results derived from the general database 9.

In practice, concept identifier mechanisms 6A, 6B and 6C are all provided by a common software facility. Further details regarding the process of concept identification, concept models and generation of indications of relevance can be found in GB2420426.

A low relevance indication at the output of relevance calculator 5 signals that specialist database 4 does not contain information which is relevant to the query posed; or, from the reverse view point, that the query is not relevant to the website. In this way the relevance calculator 5 is used as a means to filter queries considered to be irrelevant to the website or inappropriate to be associated with the company. For example, should a user of the bank's search engine enter the query ‘wildlife on river banks’ the website's internal search engine may still retrieve results, irrespective of their relevance. However, it is unlikely that the bank would wish for a user to be directed to the bank should the phrase be entered into an internet search engine.

The indication of relevance and the query are sent to a store 11 which is divided into sections relating to each of the web pages WP1 to WPn on the website.

The query and indication of relevance are stored as an entry in the section corresponding to the web page selected as a result of the visitor's query. Also contained within each entry is the frequency that the query has been used to access the associated web page.

A processor 12 is programmed to examine each new or updated entry in the store 11 and to compare the content of the store with criteria held in a store 13. This criteria, which is manually entered from a user interface 14, defines two criteria as follows.
(i). minimum values for frequency and relevance required for the entry to deserve the generation of an intent page; and
(ii) minimum values (in general, higher than those specified at (i) above) for frequency and relevance required for a query to justify advertising expenditure.

The criteria held in store 13 may also include a bar against processing of certain queries or concepts which are known not to be relevant or considered inappropriate to the content of the website.

When a query is entered into a sector of the store 11, the processor 12 determines whether the criteria mentioned at (i) above are met for that particular query and, if so, selects a template page from the template library 15 which corresponds to and has a hyperlink to, the web page which the query has accessed. The wording of the query, is then added into the template page using methods well known in the art for maximise web pages prominence to internet search engines, thereby producing a “intent” web page carrying information that carries the intention of users as expressed in user queries presented to the internal search engine 3. Because an intent page contains this material expressed by users in their own way, users are directed via the link on the intent page efficiently to the information they require. An intent page will normally, but not always, contain no information other than the query and the links (including indicia associated with the link).

Each intent page is stored in a library 16. All of the intent pages are made available to internet search engine databases via the interface 2.

When a user comes to enter a query in an internet search engine for which an intent page has been generated, the internet search engine will find and display the intent page in its generated results. A user accessing the intent page will be directed to the relevant web page of the Company's website.

Before and after the generation of an intent page, the processor addresses at least one internet search engine, via ranking calculator 18, with the query that is to be entered on the intent page. In this way the ranking calculator is able to assess the benefit achieved by introducing the intent page. If this benefit is smaller than a value defined by the criteria store 13, the intent page is removed.

When a query is entered into a sector of the store 11, the processor 12 also determines whether the criteria mentioned at (ii) above are met for that particular query and, if so, feeds the query to an advertisement placing mechanism 17. This automatically requests the internet search engine administrator to record that phrase as a key phrase which, when entered into the internet search engine will cause advertising material in the form of a link to the relevant webpage, to appear on the user's screen, or otherwise to increase the ranking of the webpage or website. The ranking calculator is controlled by the processor so as to assess the increase in traffic to each web page following placement of such an advertisement order and to cancel it if the improvement is not greater than a minimum value stored at 13.

It should be noted that not all of hardware/processes need to be housed/performed at the same physical location. For example, the website and/or the database 9 may be stored remotely from the rest of the system.

1. A mechanism for improving the effectiveness of an internet search engine at directing a user to a relevant page of a website that has an internal search engine comprising:
i) an interface for connecting the mechanism to the internet
ii) a relevance calculator associated with the internal search engine for producing an indication of the relevance of a user query to information in the website;
iii) a store of information containing for each page of the website
a record of each query which has been directed to that page,
the frequency of the query directed to that page, and
the relevance of the query as determined by (ii) above;
iv) means for selecting from item (iii) above web pages which are accessed by relevant queries; and
v) means for generating intent pages (as herein defined) for such relevant queries, each intent page containing the query and a link to the webpage that it accessed, and for making the intent pages visible to the internet search engine thereby improving the efficiency with which users are directed to a relevant page.

2. A mechanism according to claim 1, characterised by means for selecting relevant queries and generating associated intent pages when a criterion is met, this criterion being dependant on the frequency and/or relevance values held in the aforementioned store of information.

3. A mechanism according to claim 1 comprising means for producing an advertisement placement signal when a second criterion is met, the second criterion being dependant on the aforementioned frequency and or relevance values of a query, this signal serving as an instruction or recommendation that internet advertising be purchased in respect of the query.

4. A mechanism according to claim 2 further characterised by ranking calculator for assessing the improvement in the rank of the website or a page of the website as a result of the generation of an intent page and means for removing the relevant intent page if the ranking is not improved by it.

5. A mechanism according to claim 3 further characterised by ranking calculator for assessing the improvement in the rank of the website or a page of the website as a result of the placing of an advertisement and means for removing the relevant advertisement if the ranking is not improved by it.
